(19) United States
(12) Patent Application Publication
(10) Pub. No.: US 2025/0050356 A1
(43) Pub. Date: Feb. 13, 2025

(54) Apparatus and Method for Separating Particulate Matter From a Fluid

(71) Applicant: PetroQuip Energy Services, LLC, Waller, TX (US)

(72) Inventors: Robert Joe Coon, Missouri City, TX (US); John Lee Emerson, Katy, TX (US); Josh Hornsby, Waller, TX (US)

(73) Assignee: PetroQuip Energy Services, LLC, Waller, TX (US)

(21) Appl. No.: 18/678,812

(22) Filed: May 30, 2024

Related U.S. Application Data
(60) Provisional application No. 63/469,664, filed on May 30, 2023.

(51) Int. Cl. B04C 3/06; B04C 5/081

(52) U.S. Cl. CPC B04C 3/06; B04C 5/081

(57) ABSTRACT

An apparatus and method for separating particulate matter included in a fluid from the fluid. In one embodiment, the apparatus comprises a particle separator for separating particulate matter included in a fluid from the fluid, principally comprising a housing, a vortex initiator, and a separation body. The housing may comprise a generally tubular body formed to provide a first internal shoulder against which a flange of the vortex initiator may be secured, and a second internal shoulder against which the separation body may be secured. The housing may be formed having an inlet portion disposed between the first and second internal shoulders, the inlet portion may be provided with one or more ports disposed radially to direct incoming fluid toward an outer surface of the vortex initiator. The separation body may comprise a generally tubular body which may be formed to provide at least one generally conical internal surface profile.

### CROSS-REFERENCE TO RELATED APPLICATIONS

This U.S. Non-Provisional application claims priority to U.S. Provisional Application Ser. No. 63/469,664 filed May 30, 2023, the entire contents of which are incorporated herein by reference thereto.

### STATEMENT REGARDING FEDERALLY SPONSORED RESEARCH OR DEVELOPMENT

Not applicable.

### BACKGROUND OF THE INVENTION

### Field of the Invention

The present invention is directed to an apparatus and method for separating particulate matter included in a fluid from the fluid. In one embodiment, the present invention is directed to a production separator for use in oil and gas well applications.

### Background of the Invention

Fluids produced from a wellbore often include particulate matter, such as sand, which may be detrimental to the performance of production equipment or may cause production equipment to fail. For instance, such particulate matter may cause a submersible pump to fail. Accordingly, it is typically desirable to include a downhole separator upstream of production equipment in order to remove particulate matter from the fluid that is being produced.

A variety of separator designs are currently available. However, the conventional designs have numerous drawbacks. Drawbacks include that the conventional designs often incorporate complex, multiple chamber designs. Other drawbacks to conventional designs include that the conventional designs have undesirable features such as directional vanes that may detract from the effectiveness of the separator, the efficiency at which the fluid may pass through the separator, or the cost to produce the separator.

Consequently, there is a need for an improved apparatus and method for separating particulate matter from a fluid.

### BRIEF SUMMARY OF SOME OF THE PREFERRED EMBODIMENTS

These and other needs in the art are addressed in an embodiment by a particle separator for separating particulate matter included in a fluid from the fluid, principally comprising a housing, a vortex initiator, and a separation body. The housing may comprise a generally tubular body formed to provide a first internal shoulder against which a flange of the vortex initiator may be secured, and a second internal shoulder against which the separation body may be secured. The housing may be formed having an inlet portion disposed between the first internal shoulder and the second internal shoulder. The inlet portion may be provided with one or more ports disposed radially to direct incoming fluid toward an outer surface of the vortex initiator. The separation body may comprise a generally tubular body that may be formed to provide at least one generally conical internal surface profile of reducing radius between a proximal and distal portion of the separation body.

These and other needs in the art are addressed in another embodiment by a particle separator for separating particulate matter included in a fluid from the fluid. The particle separator includes a housing. The housing includes a generally tubular body formed to include a first internal shoulder and a second internal shoulder. The housing further includes a housing first end and a housing second end. The housing first end and the housing second end are adapted for connection to a production string. The particle separator includes a housing inlet portion, abutting the first internal shoulder. The housing inlet portion is provided with one or more ports for receiving a fluid into the housing. Each of the one or more ports is formed having an offset orientation from a longitudinal axis of the housing. The housing also includes a housing separation portion, abutting the second internal shoulder. The housing separation portion is formed having an internal diameter greater than the housing inlet portion, thereby forming the second internal shoulder. The particle separator also includes a vortex initiator. The vortex initiator has a generally tubular body having a vortex initiator first end and a vortex initiator second end. The vortex initiator first end is formed to provide a flange that is adapted to be received by the housing inlet portion and sized to allow the vortex initiator to be disposed within the housing inlet portion having the flange in contact against the first internal shoulder of the housing. The particle separator also has a separation body. The separation body has a generally tubular body having a separation body first end and a separation body second end. The separation body is formed to provide a generally conical internal surface profile of reducing internal diameter between the separation body first end and the separation body second end. The separation body is formed having an outer diameter that is adapted to be received by the housing separation portion and sized to allow the separation body to be disposed within the housing separation portion in contact against an inner surface of the housing separation portion.

These and other needs in the are also addressed by a particle separator for separating particulate matter from a fluid when the particulate matter is disposed in the fluid. The particle separator including a housing. The housing having a cylindrical or generally tubular body formed to include a first internal shoulder and a second internal shoulder. The housing further having a housing first end and a housing second end. The housing first end and the housing second end are connectible to downhole equipment. The housing also has a housing inlet portion, abutting the first internal shoulder. The housing inlet portion having one or more ports for receiving a fluid into the housing. The housing also has a housing separation portion, abutting the second internal shoulder. The particle separator also has a vortex initiator. The vortex initiator has a cylindrical or generally tubular body having a vortex initiator first end and a vortex initiator second end. The vortex initiator first end provides a flange at vortex initiator first end. The flange is secured against the first internal shoulder. The particle separator also has a separation body. The separation body has a cylindrical or a generally tubular body having a separation body first end and a separation body second end. The separation body is formed to provide a generally conical internal surface profile of reducing internal diameter between the separation body first end and the separation body second end. The separation body is formed having an outer diameter that is disposed in the housing separation portion.

In operation, a fluid containing particulate matter may be directed into the particle separator through the one or more ports of the housing. Upon entering the housing, the fluid may be directed toward an outer surface of the vortex initiator, which may cause the fluid to establish a circular flow pattern around a circumference of the vortex initiator outer surface. The circular flow pattern of the fluid may then initiate a vortex flow pattern as the fluid enters a proximal portion of the separation body, after which the fluid may follow the generally conical internal surface of the separation body. The vortex fluid flow may cause particulate matter included in the fluid to be pushed outward and distally along the conical internal surface, with the reducing radius of the separation body causing the velocity of vortex fluid flow to increase, which in turn may cause the particulate matter to be biased against the conical internal surface and subsequently discharged through a distal end of the separation body, while the fluid thus freed at least in part of the particulate matter is discharged from the separation body through a central bore of the vortex initiator.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of a particle separator for separating particulate matter included in a fluid from the fluid.

### DETAILED DESCRIPTION OF THE PREFERRED EMBODIMENTS

In the following description the term proximal is used to describe the portion of the body, component, or part being referred to that is closest to the well opening, or well mouth, and the term distal is used to refer to the portion of the body, component, or part being referred to that is furthest from the well opening.

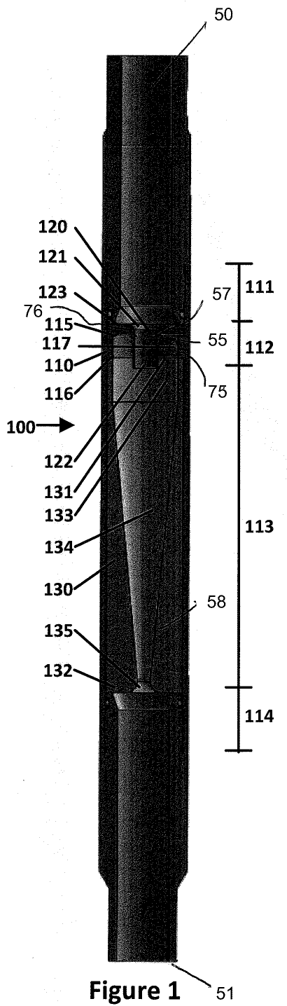

FIG. 1 illustrates an embodiment of separator 100. In embodiments, separator 100 provides an apparatus and method for separating particulate matter from a fluid when the particulate matter is disposed in the fluid. In an embodiment, separator 100 comprises housing 110, vortex initiator 120, and separation body 130.

Housing 110 may have any shape suitable for separator 100 separating particulate matter from the fluid. In embodiments, housing 110 is cylindrical or tubular. In an embodiment as shown in FIG. 1, housing 110 may be formed as a generally tubular body. Housing 110 may comprise housing first end 111. In an embodiment, housing first end 11 is located about a proximal portion of housing 110. Housing 110 may also include housing second end 114. In an embodiment, housing second end 114 may be located about a distal portion of housing 110. Housing 110 may further include housing inlet portion 112. In embodiments, housing inlet portion 112 is located adjacent to housing first end 111. In addition, housing 110 may include housing separation portion 113. In embodiments, housing separation portion 113 is located between housing inlet portion 112 and housing second end 114.

In embodiments as further shown in FIG. 1, housing first end 111 and housing second end 114 may be connected to any suitable downhole equipment 50, 51, respectively. Downhole equipment 50, 51 may include a drill string, top sub, production string or the like. In an embodiment, housing first end 111 and housing second end 114 may be adapted for connection to downhole equipment 50, 51 (i.e., production string). Housing first end 111 and housing second end 114 may be connected to downhole equipment 50, 51 by any suitable means. In embodiment, housing first end 11 and housing second end 114 may be connected to downhole equipment 50, 51 by a threaded connection. In an embodiment, housing first end 111 and/or housing second end 114 have one or more scaling elements. The sealing elements may include any sealing elements (not illustrated) that are suitable for preventing fluid from communicating through the means of connection of housing first end 111 and housing second end 114 to the production string (downhole equipment 50). In embodiments, housing first end 11 and housing second end 114 may be provided with one or more internal surface profiles adapted to receive the one or more sealing elements that may prevent a fluid from communicating through the means of connection. For example, housing first end 111 and/or housing second end 114 may be provided with one or more seals such that when housing 110 is connected to a production string (downhole equipment 50, 51), the one or more seals may prevent a fluid passing through housing 110 from escaping the production string via the means of connection provided by housing first end 111 and/or housing second end 114.

Housing inlet portion 112 may provide housing 110 with first internal shoulder 115 and second internal shoulder 116. First internal shoulder 115 is located proximally in relation to second internal shoulder 116. In embodiments, housing inlet portion 112 may be formed to provide a housing inlet portion central bore 55 having an internal diameter less than the overall diameter of housing 110, thereby forming first internal shoulder 115 and second internal shoulder 116. In embodiments, first internal shoulder 115 and/or second internal shoulder 116 may have one or more scaling elements (not illustrated). The sealing elements may include any sealing elements (not illustrated) that are suitable for preventing fluid from communicating between first internal shoulder 115 and vortex initiator 120. In an embodiment, first internal shoulder 115 and/or second internal shoulder 116 have one or more sealing elements that may prevent all or a portion of a fluid received into housing 110 from communicating between first internal shoulder 115 and vortex initiator 120, and/or between second internal shoulder 116 and separation body 130.

In addition, as shown in FIG. 1, housing inlet portion 112 may have one or more ports 117. In an embodiment, housing inlet portion 112 may be formed to provide one or more ports 117 for receiving a fluid into housing 110. The fluid is thereby received into separator 100. Each of the one or more ports 117 may be located between first internal shoulder 115 and second internal shoulder 116. One or more ports 117 may be disposed at any location of housing inlet portion 112 suitable to receive a fluid into housing 110. In embodiments, each of the one or more ports 117 may be disposed radially about housing inlet portion 112 in a manner such that ports 117 are oriented perpendicularly relative to an internal surface or external surface of housing inlet portion 112 in relation to a central axis of housing 110. In alternate embodiments, each of the one or more ports 117 may be oriented such that they are at an angle offset from perpendicular relative to an internal surface or external surface of housing inlet portion 112 in relation to a central axis of housing 110. For example, each of the one or more ports 117 may be oriented in a manner so as to direct a flow of fluid being received into housing inlet portion 112 toward or around an outer surface of vortex initiator 120 when vortex initiator 120 is disposed within housing 110 in a manner which will be described herein. In this manner, the orientation of the one or more ports 117 may initiate a rotational fluid flow of the incoming fluid around at least a portion of vortex initiator 120, which may thereby initiate a vortex fluid flow throughout separator 100.

FIG. 1 also illustrates an embodiment of separator 100 having housing separation portion 113. In an embodiment as shown, housing separation portion 113 may be formed to provide housing 110 with a uniform internal radius extending from second internal shoulder 116 to housing second end 114, such that housing separation portion 113 is suitably adapted to receive separation body 130.

In an embodiment, all or a portion of housing inlet portion 112 located proximally to first internal shoulder 115 may be adapted to provide a means of securing vortex initiator 120 within housing 110. In an alternate embodiment, vortex initiator 120 may be secured within housing 110 by being trapped between first internal shoulder 115 and a distal end of a portion of a production string or top sub secured to housing 110 at housing first end 111. Similarly, in an embodiment, all or a portion of housing separation portion 113 located distally to second internal shoulder 116 may be adapted to provide a means of securing separation body 130 within housing 110. In an alternate embodiment, separation body 130 may be secured within housing 110 by being trapped between second internal shoulder 116 and a proximal end of a portion of a production string or bottom sub secured to housing 110 at housing second end 114.

Housing 110 may be formed of any material suitable for use in any downhole environment. In an embodiment, housing 110 may be composed of any material suitable for use in the environments in which separator 100 may be placed into operation that may be capable of withstanding erosion from high velocity particulate matter that may pass through separator 100 and the loads to which separator 100 may be exposed. In embodiments, housing 110 may be composed of steel, surface hardened steel, hard coated steel, ceramic, or any combinations thereof.

Vortex initiator 120 may have any suitable shape in which vortex initiator 120 may have a vortex initiator central bore 57. In an embodiment, vortex initiator 120 may have a cylindrical or tubular shape. In an embodiment as shown in FIG. 1, vortex initiator 120 may be formed as a generally tubular body. In embodiments, vortex initiator 120 may be formed having a generally tubular shape that may provide vortex initiator 120 with vortex initiator central bore 57. Vortex initiator 120 may further comprise vortex initiator first end 121 located about a proximal portion of vortex initiator 120, and vortex initiator second end 122 located about a distal portion of vortex initiator 120. Vortex initiator 120 may be formed to further provide flange 123 at vortex initiator first end 121.

Flange 123 may have any size suitable for used with vortex initiator 120. In an embodiment, flange 123 may be sized to provide an outer diameter that corresponds to an inner diameter of a proximal portion of housing inlet portion 112 such that when vortex initiator 120 is secured within housing 110, a distal portion of flange 123 may be secured against first internal shoulder 115 of housing 110. In embodiments, flange 123 may have sealing elements (not shown). In an embodiment, the sealing elements may be any sealing elements suitable to restrict or prevent fluid communication between the distal surface of flange 123 and first internal shoulder 115, or between the proximal surface of flange 123 and a tubular body connected to separator 100 at housing first end 111, respectively. In embodiments, the distal and proximal surfaces of flange 123 may be provided with one or more surface features to accommodate one or more sealing elements that may restrict or prevent fluid communication between the distal surface of flange 123 and first internal shoulder 115, or between the proximal surface of flange 123 and a tubular body connected to separator 100 at housing first end 111, respectively.

Vortex initiator central bore 57 may be of any size suitable for use with separator 100. In an embodiment, vortex initiator 120 may be sized to accommodate a desired rate of flow of fluid that has been freed at least in part of particulate matter following separation in a manner that will be described herein. In embodiments, vortex initiator central bore 57 may be formed to include one or more chamfered surfaces at vortex initiator first end 121 or vortex initiator second end 122. In embodiments, vortex initiator 120 may be formed to provide an outer surface which may reduce in diameter while traversing from a proximal portion of flange 123 toward vortex initiator second end 122, as shown in the embodiment illustrated in FIG. 1. In embodiments, vortex initiator 120 may be provided with an outer surface distal to flange 123 that is generally smooth, or free from any surface features that may disrupt or direct flow of a fluid entering separator 100 through the one or more ports 117.

Vortex initiator 120 may be formed from any material suitable for use in any downhole environment. In an embodiment, vortex initiator 120 may be composed of any material suitable for use in the environments in which separator 100 may be placed into operation that may be capable of withstanding erosion from high velocity particulate matter that may pass through separator 100 and the loads to which separator 100 may be exposed. For example, vortex initiator 120 may be formed from steel, surface hardened steel, hard coated steel, ceramic, or any combinations thereof. Separation body 130 may have any suitable shape for use in separator 100 and in which separation body 130 may have a separation body central bore 58. In an embodiment, separation body 130 may have a cylindrical or tubular shape. In an embodiment as shown in FIG. 1, separation body 130 may be formed as a generally tubular body that may provide separation body 130 with separation body central bore 58. Separation body 130 may further comprise separation body first end 131 located about a proximal portion of separation body 130, and separation body second end 132 located about a distal portion of separation body 130.

Separation body 130 may have any outer diameter suitable for use in separator 100. In embodiments, an outer diameter of separation body 130 may be sized to correspond to an inner diameter of housing separation portion 113, and separation body first end 131 may be formed having a wall thickness that may be sized such that when separation body 130 is secured within housing 110, a proximal portion of separation body 130 may be secured against second internal shoulder 116 of housing 110. In embodiments, separation body 130 may have scaling elements (not shown). In an embodiment, the sealing elements may be any sealing elements suitable to restrict or prevent fluid communication between the proximal surface of separation body first end 131 and second internal shoulder 116, or between the distal surface of separation body second end 132 and a downhole equipment 51 (i.e., tubular body) connected to separator 100 at housing second end 114, respectively. In embodiments, the proximal and distal surfaces of separation body 130 may be provided with one or more surface features to accommodate one or more sealing elements that may restrict or prevent fluid communication between the proximal surface of separation body first end 131 and second internal shoulder 116, or between the distal surface of separation body second end 132 and downhole equipment 51 (i.e., a tubular body) connected to separator 100 at housing second end 114, respectively.

Separation body central bore 58 may be formed to provide one or more internal portions, at least one of which may be generally conical in shape having an internal diameter that reduces in size while traversing from a proximal end of that internal portion toward a distal end of that internal portion. In the embodiment illustrated in FIG. 1, separation body 130 is shown having three internal portions, including proximal internal portion 133, central internal portion 134, and distal internal portion 135. In such embodiments, proximal internal portion 133 may be formed having an internal diameter that is substantially uniform, as shown in FIG. 1. Central internal portion 134 may be provided with an internal surface profile that is generally conical, for example in the manner just described. Distal internal portion 135 may be formed having an internal profile that may expand while traversing from a proximal end of distal internal portion 135 toward a distal end of distal internal portion 135. In such embodiments, the internal surface profile of distal internal portion 135 may be formed as a radius, as shown in FIG. 1, or any other suitable internal surface profile.

In embodiments, proximal internal portion 133 may be formed having an axial length that may extend past vortex initiator second end 122 when vortex initiator 120 and separation body 130 are secured within housing 110, as shown in FIG. 1. In alternate embodiments (not illustrated), proximal internal portion 133 may be formed having an axial length that may not extend past vortex initiator second end 122 when vortex initiator 120 and separation body 130 are secured within housing 110.

Separation body 130 may be composed of any material suitable for use in a downhole environment. In an embodiment, separation body 130 may be formed from any material suitable for use in the environments in which separator 100 may be placed into operation that may be capable of withstanding erosion from high velocity particulate matter that may pass through separator 100 and the loads to which separator 100 may be exposed. For example, separation body 130 may be formed from steel, surface hardened steel, hard coated steel, ceramic, or any combinations thereof.

In operation, separator 100 may be secured to downhole equipment 50 and/or downhole equipment 51 (i.e., production string tubing or equipment such that the production tubing or equipment may be connected to separator 100 at housing first end 111 and/or housing second end 114). In the embodiment illustrated in FIG. 1, separator 100 is shown connected to downhole equipment 50 (i.e., tubing) at housing first end 111, and connected to downhole equipment 51 (i.e., tubing) at housing second end 114. Once connected to suitable downhole equipment 50, 51 (i.e., tubing or equipment), downhole equipment 50, 51 (i.e., production string) may be deployed into a wellbore at a desired depth. In operation, a fluid including particulate matter may enter separator 100 through any of the one or more ports 117 of housing 110. Upon thus entering housing 110, the fluid including particulate matter may then be directed toward inner surface 75 of housing 110, with the angle at which the fluid may be directed toward inner surface 75 of housing 110 being imparted by the orientation of the one or more ports 117 through which the fluid entered housing 110, as previously described. In this manner, the incoming fluid including particulate matter may initially follow a circular flow pattern around a circumference of outer surface 76 of vortex initiator 120. This circumferential flow of the fluid around inner surface 75 of housing 110 may cause heavier particles in the fluid to be biased toward inner surface 75 of housing 110. As the flow of the fluid enters separation body 130, the speed at which particles may be biased toward an inner surface of separation body 130 may be caused to increase, in turn causing the particles to be biased to travel toward distal internal portion 135 and/or separation body second end 132.

In this manner, the flow pattern of the fluid may follow a vortex flow pattern as the fluid enters a proximal internal portion 133 of separation body 130, after which the fluid may follow the at least one generally conical central internal portion 134 of separation body 130. This vortex flow pattern may cause particulate matter included in the fluid to be pushed outward and distally along the internal surface of the at least one generally conical central internal portion 134 of separation body 130, with the reducing diameter of the corresponding internal surface causing the velocity of vortex fluid flow to increase, which in turn may cause the particulate matter to be biased against the conical internal surface and subsequently discharged through the distal end (distal internal portion 135) of separation body 130 while the fluid thus freed at least in part of the particulate matter is discharged from separation body 130 and separator 100 through the vortex initiator central bore 57.

Notable advantages of the design of separator 100 over current separator designs include separator 100 providing a simpler design wherein fluid is directed into a single chamber rather than through multiple concentric chambers, and wherein features such as vanes are not necessary in order to impart a desired fluid flow pattern. This simpler design of separator 100 additionally offers cost and performance advantages over current separator designs. Further differentiating separator 100 from current designs, separator 100 may separate particulate matter from a fluid at both low and high fluid velocities, whereas designs that employ vanes may be limited to fluid velocities which correspond to, or are matched to, the vanes employed in their design.

Although the present invention and its advantages have been described in detail, it should be understood that various changes, substitutions and alterations may be made herein without departing from the spirit and scope of the invention as defined by the appended claims.

What is claimed is:

1. A particle separator for separating particulate matter from a fluid when the particulate matter is disposed in the fluid, comprising:
a housing, wherein the housing comprises a cylindrical or generally tubular body formed to include a first internal shoulder and a second internal shoulder, the housing further comprising:
a housing first end and a housing second end, wherein the housing first end and the housing second end are connectible to downhole equipment,
a housing inlet portion, abutting the first internal shoulder, the housing inlet portion having one or more ports for receiving a fluid into the housing, and
a housing separation portion, abutting the second internal shoulder;
a vortex initiator, wherein the vortex initiator comprises a cylindrical or generally tubular body having a vortex initiator first end and a vortex initiator second end,
wherein the vortex initiator first end provides a flange at vortex initiator first end,
wherein the flange is secured against the first internal shoulder; and
a separation body, wherein the separation body comprises a cylindrical or a generally tubular body having a separation body first end and a separation body second end,
wherein the separation body is formed to provide a generally conical internal surface profile of reducing internal diameter between the separation body first end and the separation body second end,
wherein the separation body is formed having an outer diameter that is disposed in the housing separation portion.

2. The particle separator of claim 1, wherein the housing comprises a generally tubular body.

3. The particle separator of claim 1, wherein the downhole equipment comprises a production string.

4. The particle separator of claim 1, wherein the one or more ports are disposed at an angle offset from perpendicular relative to a surface of the housing inlet portion in relation to a central axis of the housing.

5. The particle separator of claim 1, wherein the vortex initiator comprises a generally tubular body.

6. The particle separator of claim 1, wherein the separation body comprises a generally tubular body.

7. The particle separator of claim 1, wherein the housing first end comprises one or more sealing elements.

8. The particle separator of claim 1, wherein the housing second end comprises one or more sealing elements.

9. The particle separator of claim 1, wherein the first internal shoulder comprises one or more sealing elements.

10. The particle separator of claim 1, wherein the second internal shoulder comprises one or more sealing elements.
